(19) United States
(12) Patent Application Publication
(10) Pub. No.: US 2002/0089587 A1
(43) Pub. Date: Jul. 11, 2002

(54) Intelligent buffering and reporting in a multiple camera data streaming video system

(75) Inventors: Patrick White, Aloha, OR (US); Brian Hunt, Portland, OR (US); G. David Ripley, Portland, OR (US)

Correspondence Address: ELMER GALBI, 13314 VERMEER DRIVE, LAKE OSWEGO, OR, 97035

(73) Assignee: iMove Inc., Portland, OR

(21) Appl. No.: 10/013,187

(22) Filed: Dec. 7, 2001

Related U.S. Application Data
(63) Continuation-in-part of application No. 09/861,434, filed on May 18, 2001.
(63) Continuation-in-part of application No. 09/860,892, filed on May 18, 2001.
(60) Provisional application No. 60/254,453, filed on Dec. 7, 2000.
(60) Provisional application No. 60/205,942, filed on May 18, 2000.

(51) Int. Cl. G06F 3/00; H04N 5/445

(52) U.S. Cl. 348/105; 725/46

(57) ABSTRACT

Multiple streams of data are streamed to a user's terminal with images from different cameras. Low resolution thumbnail images tell the user what image streams are available. A focus stream provides high resolution images from a selected camera. A user can switch the focus stream to another stream by clicking on the associated thumbnail. An intelligent buffer is provided which anticipates the commands that will be issued by a user. Unused bandwidth is utilized to transmit data to the intelligent buffer to prepare to execute the anticipated commands. The data so accumulated is used to execute commands without any significant (or with less) latency. Data concerning a user and data concerning the operation of the system is gathered and added to a data base of user actions. Reports concerning the usage are later prepared.

### RELATED APPLICATIONS

This application is a continuation in part of (a) application No. 60/205,942 filed May 18, 2000 (b) a continuation of in part of application No. 60/254,453 filed Dec. 7, 2000, (c) a continuation in part of application Ser. No. 09/861,434 filed May 18, 2001, and (d) a continuation in part of application Ser. No. 09/860,962 filed May 18, 2001. Each of the above four applications is hereby incorporated herein by reference. Priority is claimed to the above four applications.

### FIELD OF THE INVENTION

The present invention relates to transmitting video information and more particularly to systems for streaming and displaying video images .

### BACKGROUND OF THE INVENTION

In many situations, a scene or object is captured by multiple cameras, each of which capture a scene or object from a different angle or perspective. For example, at an athletic event multiple cameras, each at a different location, capture the action on the playing field. While each of the cameras is viewing the same event, the image available from the different cameras is different due to the fact that each camera views the event from a different angle and location. Such images can not in general be seamed into a single panoramic image.

The technology for streaming video over the Internet is well developed. Streaming video over the internet, that is, transmitting a series of images requires a substantial amount of bandwidth. Transmitting multiple streams of images (e.g. images from multiple separate cameras) or transmitting a stream of panoramic images requires an exceptionally large amount of bandwidth.

A common practice in situations where an event such as a sporting event is captured with multiple cameras, is to utilize an editor or technician in a control room to select the best view at each instant. This single view is transmitted and presented to users that are observing the event on a single screen. There are also a number of known techniques for presenting multiple views on a single screen. In one known technique, multiple images are combined into a single combined image which is transmitted and presented to users as a single combined image. With another technique the streams from the different cameras remain distinct and multiple streams are transmitted to a user who then selects the desired stream for viewing. Each of the techniques which stream multiple images require a relatively large amount of bandwidth. The present invention is directed to making multiple streams available to a user without using an undue amount of bandwidth.

Co-pending application Ser. Nos. 09/860,962 and 09/861,434 describe a system for capturing multiple images from multiple cameras and selectively presenting desired views to a user. Multiple streams of data are streamed to a user's terminal. One data stream (called a thumbnail stream) is used to tell the user what image streams are available. In this stream, each image is transmitted as a low resolution thumbnail. One thumbnail is transmitted for each camera and the thumbnails are presented as small images on the user's screen. The thumbnail stream uses a relatively small amount of bandwidth. Another data stream (called the focus stream) contains a series of high resolution images from a selected camera. The images transmitted in this streams are displayed in a relatively large area on the viewer's screen. A user can switch the focus stream to contain images from any particular camera by clicking on the associated thumbnail. In an alternate embodiment in addition to the thumbnails from individual cameras a user is also provided with a thumbnail of a panoramic image (e. g. a full 360 degree panorama or a portion thereof) which combines into a single image, the images from multiple cameras. By clicking at a position on the panoramic thumbnail, the focus stream is switched to an image from a viewpoint or view window located at the point in the panorama where the user clicked. In other alternate embodiments a variety of other data streams are also sent to the user. The other data streams sent to the user can contain (a) audio data, (b) interactivity markup data which describes regions of the image which provide interactivity opportunities such as hotspots, (c) presentation markup data which defines how data is presented on the user's screen, (d) a telemetry data stream which can be used for various statistical purposes, navigation aids, etc. In still another embodiment one data stream contains a low quality base image for each data stream. The base images serve as the thumbnail images. A second data stream contains data that is added to a particular base stream to increase the quality of this particular stream and to create the focus stream.

### SUMMARY OF THE INVENTION

The present invention provides an extension and/or improvement to the system described in the above referenced co-pending applications. With systems described in the above described co-pending applications, a user can issue commands that must be sent from the client to the server and which cause the server to take some action. Examples of such commands are: a command to change which stream is the focus stream, a command to change the direction in which a video is viewed (i.e. forward or reverse), a command to stop the video and freeze on the current frame, a command to change the location of the view window in a panorama, etc. In general, when a user issues a command to make a change in the video being viewed, a signal must be sent from the client to the server, the server must change the data stream being sent to the client, the buffer at the client continuing to receive data relative to the existing data stream must be flushed, and finally the buffer must be provided with data relative to the newly selected data stream. Performing such operations involves a certain amount of time, and hence, when a user issues a command to make a change in the video being viewed, there is some latency between when the command is given and when the newly selected video appears. One aspect of the present invention is directed to minimizing the latency in changing the video being viewed. The latency is decreased by providing the system with an intelligent buffer system. The intelligent buffer system monitors a user's performance and determines from his past history, what action he is most likely to take. The intelligent buffer system then users any available extra bandwidth to accumulate data in the anticipation of such a change. Prior to having any history relative to a particular user, the system uses a default profile. As a user makes choices, a profile for that user is built and this profile is used to anticipate changes make by that user. For example, one particular user may regularly sequence between the different views available. Another user might regularly stop and reverse the direction of view of the video, and yet another user might normally pan right or left in a panorama. The intelligent buffer system will build a profile for each user and then store data in anticipation of that user's normal changes. A user's behavior may well change and evolve over time, and the intelligent buffer system would adjust accordingly.

In the above described feature of the invention statistics concerning a user's action were gathered for use by the intelligent buffer system. Another aspect of the present invention also relates to gathering statistics concerning actions taken by a user. However, in this aspect of the invention the statistics are gathered for the purpose of preparing reports. A wide variety of statistics concerning choices a user makes can be gathered. The data is gathered and sent to the server. Finally the data is summarized in reports for use by various people such as system operators, content developers, and advertisers.

### BRIEF DESCRIPTION OF DRAWINGS

FIG. 1 is an overall high level diagram of a first embodiment of the invention.

FIG. 2 illustrates the view on a user's display screen.

FIG. 3 is a block diagram of a first embodiment of the invention .

FIG. 3A illustrates how the thumbnail data stream is constructed.

FIG. 4A illustrates how the user interacts with the system.

FIG. 5 illustrates how clips are selected.

FIG. 6 is program block diagram of a first embodiment of the invention.

FIG. 7 is program block diagram of a second embodiment of the invention.

FIG. 8 is a program block diagram of the reporting feature of the invention.

FIG. 9 illustrates an example of a report generated by the system.

### DETAILED DESCRIPTION

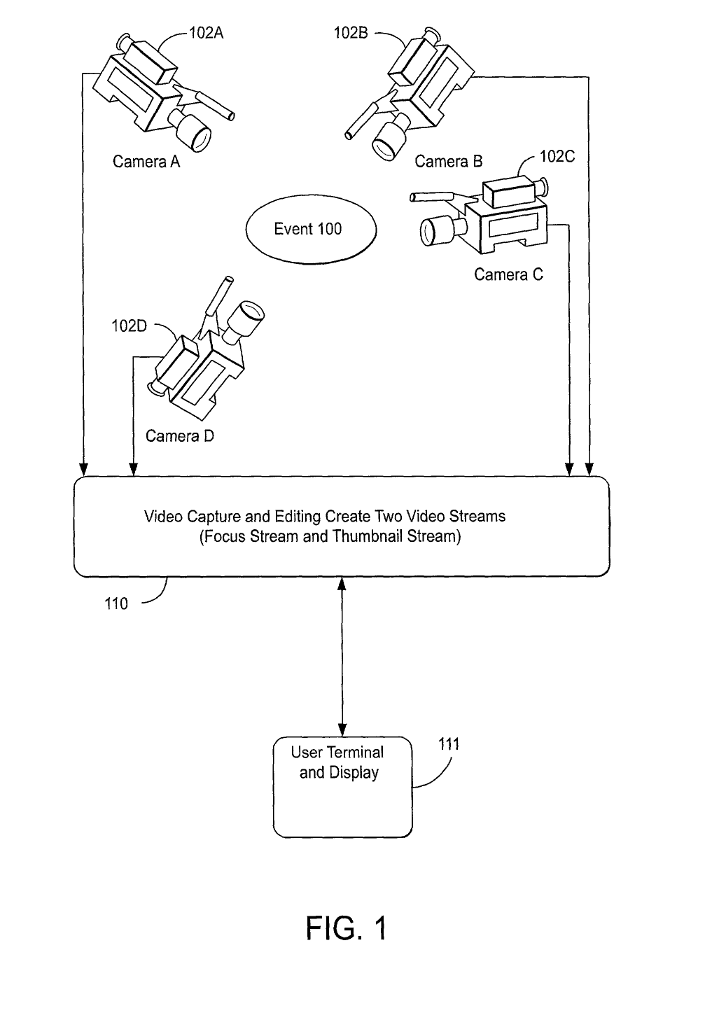

An overall diagram of a first embodiment of the invention is shown in FIG. 1. In the first embodiment of the invention, an event 100 is viewed and recorded by the four cameras 102A to 102D. The event 100 may for example be a baseball game. The images from cameras 102A to 102D is captured and edited by system 110. System 110 creates two streams of video data. One stream contains the images captured by “one” selected camera. The second stream consists of “thumbnails” (i.e. small low resolution images) of the images captured by each of the four cameras 102A to 102D.

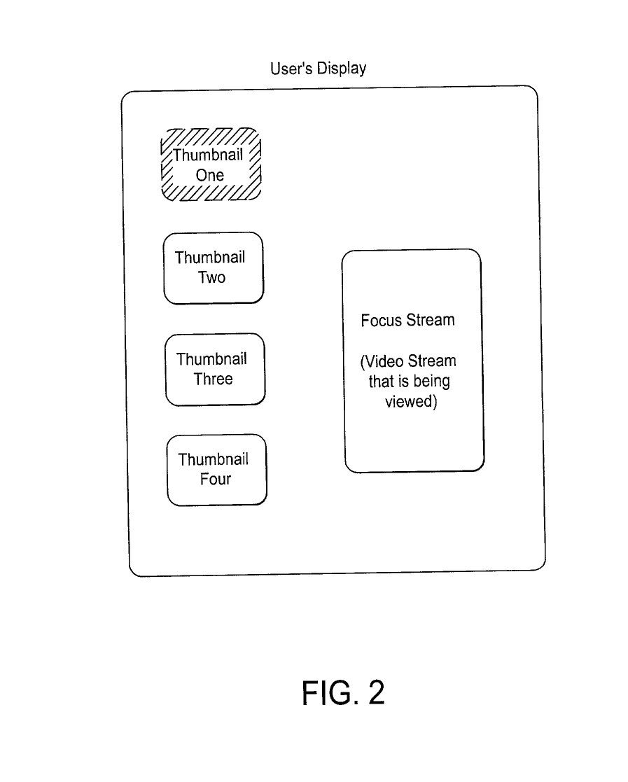

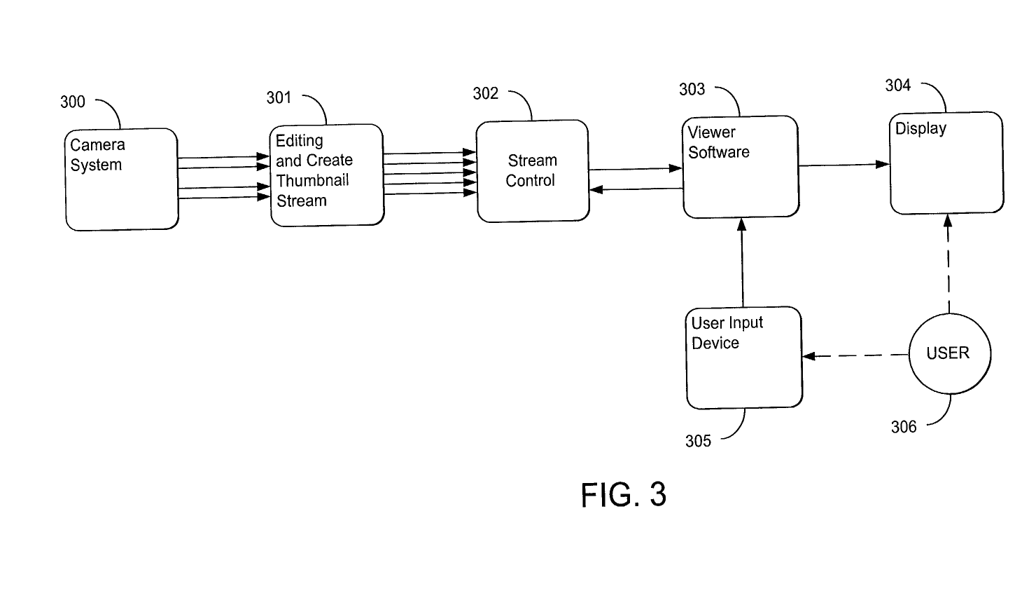

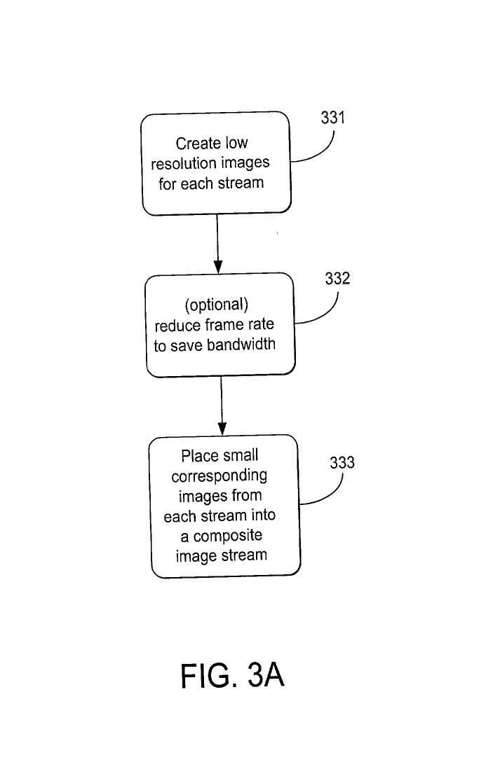

The two video streams are sent to a user terminal and display 111. The images visible to the user are illustrated in FIG. 2. A major portion of the display is taken by the images from one particular camera. This is termed the focus stream. On the side of the display are four thumbnail images, one of which is associated with each of the camera 102A to 102D. It is noted that the focus stream requires a substantial amount of bandwidth. The four thumbnail images have a lower resolution and all four thumbnail images can be transmitted as a single data stream. Examples of the bandwidth used by various data streams are given below. FIG. 3 illustrates the components in a system used to practice the invention and it shows how the user interacts with the system. Camera system 300 (which includes cameras 102A through 102D) provides images to unit 301 which edits the image streams and which creates the thumbnail image stream The data stream from each camera and the thumbnail data stream are provided to stream control 302. The user 306 can see a display 304. An example of what appears on display 304 is shown in FIG. 2. The user has an input device (for example a mouse) and when the user “clicks on” one of the thumbnails, viewer software 303 sends a message to control system 302. Thereafter images from the camera associated with the thumbnail which was “clicked” (i.e. selected) are transmitted as the focus stream.

FIG. 3A is a block diagram of the program that creates the thumbnail data stream. First as indicated by block 331, a low resolution version of each data stream is created. Low resolution images can, for example, be created by selecting and using only every fourth pixel in each image. Creating the low resolution image in effect shrinks the size of the images. As indicated by block 332, if desired the frame rate can be reduced by eliminating frames in order to further reduce the bandwidth required. The exact amount that the resolution is reduced depends on the particular application and on the amount of bandwidth available. In general a reduction in total pixel count of at least five to one is possible and sufficient. Finally, as indicated by block 333 the corresponding thumbnail images from each data stream are placed next to each other to form composite images . The stream of these composite images is the thumbnail data stream. It should be noted that while in the data stream the thumbnails are next each other, when they are displayed on the client machine, they can be displayed in any desired location on the display screen.

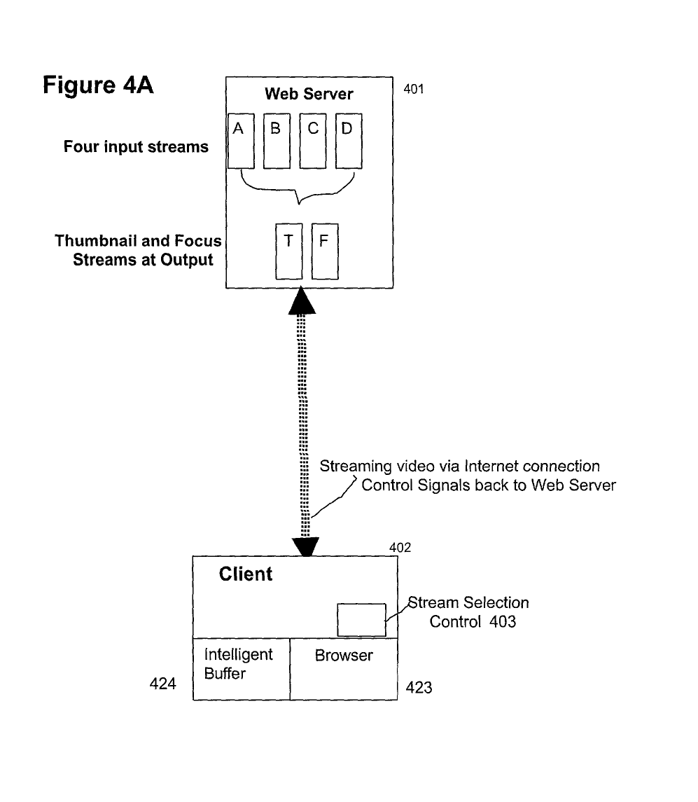

As shown in FIG. 4A, in the first embodiment of the invention, system 110 includes a server 401 which streams video to a web client 402. The server 401 takes the four input streams A to D from the four camera 102A to 102 D and makes two streams T and F. Stream T is a thumbnail stream, that is, a single stream of images wherein each image in the stream has a thumbnail image from each of the cameras. Stream F is the focus stream of images which transmits the high resolution images which appear on the user's display. As shown in FIG. 2, the users display shows the four thumbnail images and a single focus stream.

The web client 402 includes a stream selection control 403. This may for example be a conventional mouse. When the user, clicks on one of the thumbnails, a signal is sent to the server 401 and the focus stream F is changed to the stream of images that coincides with the thumbnail that was clicked. In this embodiment server 401 corresponds to stream control 302 shown in FIG. 3 and client 402 includes components 303, 304 and 305 shown in FIG. 3.

As indicated by block 301, the data streams from the cameras are edited before they are sent to users. It is during this editing step that the thumbnail images are created as indicated in FIG. 3A. The data streams are also compressed during this editing step. Various known types of compression can be used.

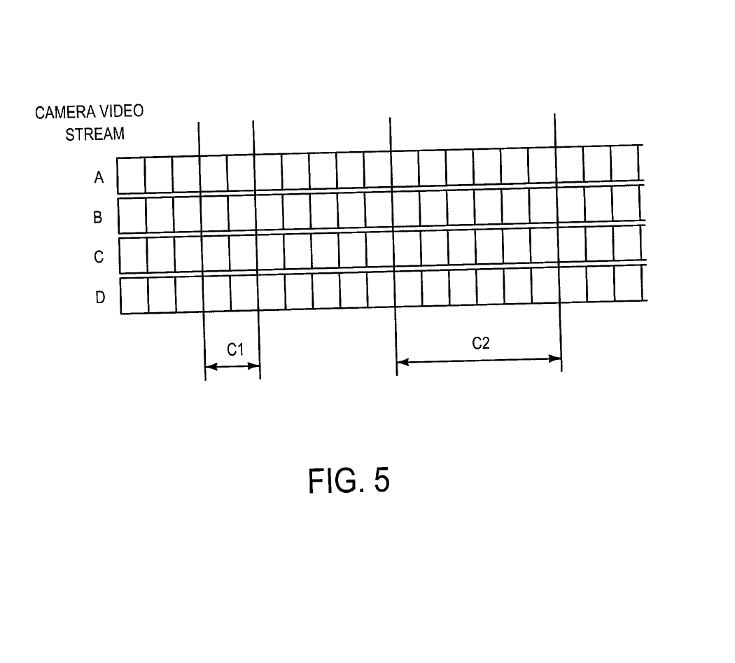

FIG. 5 illustrates one type of editing step that may be performed. The entire stream of images from all the cameras need not be streamed to the viewer. As illustrated in FIG. 5, sections of the streams, called “clips” can be selected and it is these clips that are sent to a user. As illustrated in FIG. 5, two clips C1 and C2 are made from the video streams A to D. In general the clips would be compressed and stored on a disk file and called up when there is a request to stream them to a user. For example, a brief description of clips showing the key plays from a sporting event can be posted on a web server, and a user can then select which clips are of interest. A selected clip would then be streamed to the user. That is, the thumbnail images and a single focus stream would be sent to a user. The streaming would begin with a default camera view as the focus view. When desired, the user can switch the focus stream to any desired camera by clicking on the appropriate thumbnail.

With the first embodiment of the invention, video files such as clips are stored in a memory bank (not specifically shown in the drawings) on the server, for example in a file with a “.pan” file type. The pan file would have the data stream from each camera and the thumbnail data stream for a particular period of time.

The first embodiment of the invention is made to operate with the commercially available streaming video technology marketed by RealNetworks Inc. located in Seattle, Wash. RealNetworks Inc. markets a line of products related to streaming video including products that can be used to produce streaming video content, products for servers to stream video over the Internet and video players that users can use to receive and watch streamed video which is streamed over the Internet.

The web server 401 is a conventional server platform such as an Intel processor with an MS Windows NT operating system and an appropriate communications port. The system includes a conventional web server program. The web server program can for example be the program marketed by the Microsoft Corporation as the “Microsoft Internet Information Server”. A data streaming program provides the facility for streaming video images. The data streaming program can for example be the “RealSystem Server 8” program marketed by Real networks Inc. The web server program and the streaming program are commercially available programs. Other programs from other companies can be substituted for the specific examples given above. For example the Microsoft corporation markets a streaming server termed the “Microsoft Streaming Server” and the Apple Corporation markets streaming severs called QuickTime and Darwin. The details of the programs in server 401 and client 402 are shown in co-pending application Ser. Nos. 09/860,962 and 09/861,434 the entire contents of which are hereby incorporated herein by reference.

In the specific embodiment shown “video clips” are stored on a disk storage sub-system 411. Each video clip has a file type “.pan” and it contains the video streams from each of the four cameras and the thumbnail stream. When system receives a URL calling for one of these clips, the fact that the clip has a file type “.pan” indicates that the file should be processed in accordance with the present invention.

One of the streams stored in a pan file is a default stream and this stream is sent as the focus stream until the user indicates that another stream should be the focus stream. When the user requests a change, the requests is processed by the server 401 and the appropriate T and F streams are sent to the user.

Client 402 can be a conventional personal computer with a number of programs including a Microsoft Windows operating system, and a browser program 423. The browser 423 can for example be the Microsoft Internet Explorer browser. Streaming video is handled by a commercially available program marketed under the name: “RealPlayer 8 Plus” by RealNetworks Inc. Other similar programs can also be used. For example Microsoft and Apple provide players for streaming video. It is noted that instead of working with a web server, the invention could work with other types of servers such as an intranet server or a streaming media server or in fact the entire system could be on a single computer with the source material being stored on the computer's hard disk. The interaction between the sever 401 and the client 402, and the manner the server responds to the client 402 is explained in detail in co-pending application Ser. Nos. 09/860,962 and 09/861,434 which are incorporated herein by reference.

It is noted that in one embodiment, the invention operates with panoramic images. With a panoramic image, it is usual for a viewer to select a view window and then see the particular part of the panorama which is in the selected view window. If the user clicks anywhere in the panorama, the focus stream is changed to a view window into the panorama which is centered at the point where the user clicked. With this embodiment, stream control has as one input a panoramic image and the stream control selects a view window from the panorama which is dependent upon where the user clicks on the thumbnail of the panorama. The image from this view window is then streamed to the user as the focus image.

When a user issues a command, (such as when the user clicks on a thumbnail in order to change the particular image that is the focus image) a number of actions must take place. The actions that occur in response to a user command can include:

a) The command must go from the client to the server,

b) The server must stop transmitting the stream being transmitted at that time,

c) The buffer at the client must be flushed,

d) The server must begin transmitting the next stream, and

e) The buffer at the client must fill with enough data to enable the client to display the new image.

Performing the above listed operation requires some amount of time. Naturally, with a fast computer, the time is relatively small; however, even with a fast computer, the time can be sufficient that a user would notice what the user would consider to be an appreciable delay in seeing a new image after a command is issued. Such a delay is herein referred to as system latency. One aspect of the present invention is directed to decreasing or virtually eliminating system latency.

The present invention utilizes an intelligent buffer 424 to minimize system latency. The intelligent buffer uses any available extra bandwidth to store data in anticipation of changes that a user might make. If sufficient data can be accumulated using this extra bandwidth the latency involved in executing many if not most user commands can be decreased or eliminated.

The intelligent buffer includes storage for storing the commands that are issued by a user. That is, some number (for example 20) of the last commands issued by a user are stored. The intelligent buffer also includes a program which examines the stored commands to identify a pattern in said list of commands. The identified pattern is then used to predict the next command which will be issued. If no pattern is detected, a default prediction is used. The program which examines the commands to detect a pattern and which predicts the next command utilizes known techniques and technology. The prediction program may be a part of the intelligent buffer or it may be a program which runs on the main processor in the client terminal 402.

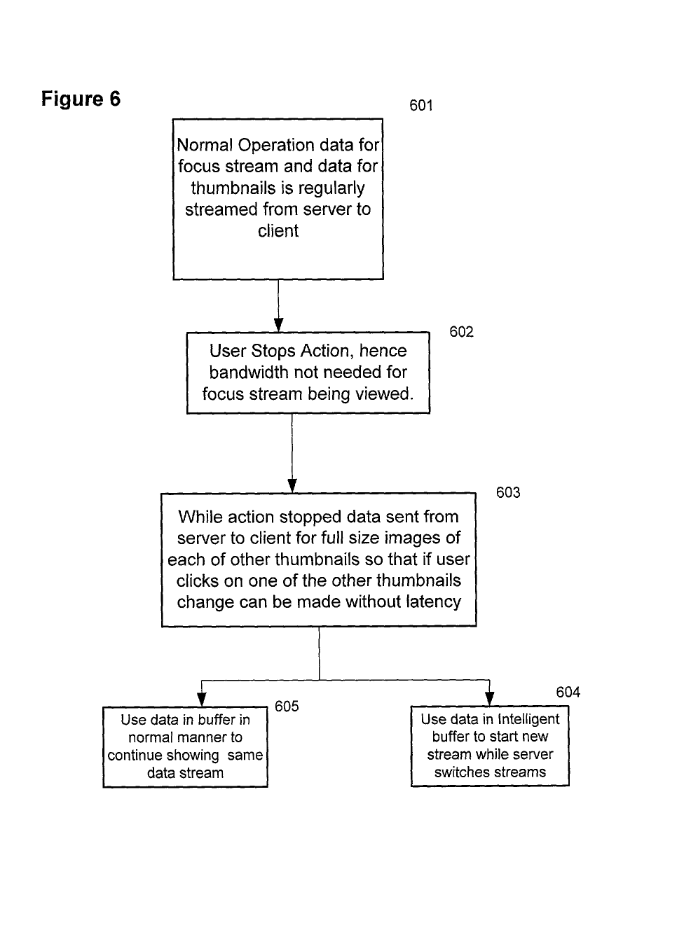

FIG. 6 is a block diagram of a program which operates the intelligent buffer in a first embodiment of the invention. Block 601 represents the normal operation of the system. During the normal operation, the data for the focus stream and the data for the thumbnails is regularly streamed from the server to the client. The buffer stores enough data so that a steady stream of images can be displayed at the frame rate at which the system is operating. The client and the server in effect operate in synchronization and the bandwidth is used to transmit the image currently being viewed. As explained below any additional available bandwidth is used by the present invention.

Block 602 indicates what occurs when the user issues a stop action command. A user would issue a stop action command so that the user can focus on one particular frame in the stream of images. When action is stopped, the bandwidth in the link between the server and the client is not needed to transmit data for the image being viewed.

Block 603 indicates what action is taken by the intelligent buffer system when action is stopped. The intelligent buffer system asks the server to transmit full size images for the images in each of the other thumbnails followed by full-sized successive images from each non-focus stream. This data is stored for possible future use. If a user clicks on one of the thumbnails to begin action with a different thumbnail forming the focus stream, the stored data is used to immediately begin showing the alternate images without any latency as indicate by block 604. Naturally if the uses clicks so as to continue with the currently being viewed focus stream the accumulated data relative to the current stream is used to continue operation without any latency as indicated by block 605.

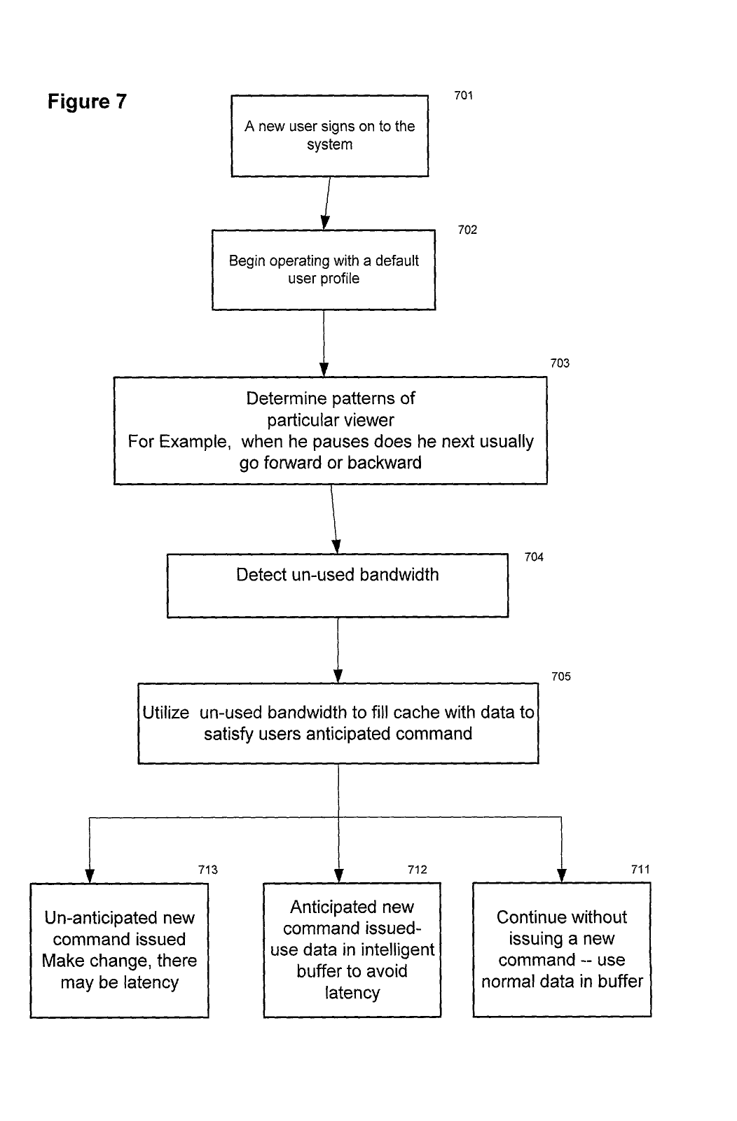

An alternate embodiment of the invention is shown in FIG. 7. In this embodiment, a user's normal pattern of operation is monitored. The normal pattern of a user is then used to anticipate the moves a user may make and data is accumulated so that such moves can be executed without any significant latency. As indicated in FIG. 7 when a new user signs on as indicated by block 701, a default profile is initially used as indicated by block 702.

As the particular user operates the system, the patterns normally followed by such a user is determined as indicated by block 703. Each command by a user is recorded and conventional techniques are used to determine if there is a pattern to the sequence of commands that a user issues. For example, when a user issues a pause command, does the user next normally issue a go forward command or does the user next normally issue a go backward command? As another example, is there a pair of thumbnails between which the user normally switches?

The intelligent buffer operates when a user issues a pause command, such that the user stops the action and continues to view a particular frame. During such a pause the bandwidth is not needed to stream additional frames to the client. Likewise the intelligent buffer can operate using any available bandwidth that is not being used to transmit the images normally being viewed. As indicated by block 705, the excess bandwidth is used to fill the intelligent buffer with data to handle the next move which the user's profile indicates that a user is likely to make. For example, is a user likely to reverse direction? If the user's profile indicates that he is likely to reverse direction in the current data stream, data for the reverse direction is displayed. As another example, is a user like to switch to a particular alternate thumbnail? If so data relative to that thumbnail's image is accumulated.

There are then three possibilities as indicated by blocks 711, 712 and 713. The user may continue viewing the same data stream and not issue a command as indicated by block 711. The user may issue a command which was anticipated and for which data was accumulated as indicated by block 712. In this case the accumulated data is used to make the switch without any latency. Finally, the ser may issue an unanticipated command. In this case, the command is executed; however, there may be some latency.

It is noted that during normal operation some amount of data is buffered to insure uninterrupted operation. This type of buffering is in accordance with the prior art. The present invention involves adding capability to the buffering mechanism and thereby making it an intelligent buffer. With an intelligent buffer, the system anticipates (based on a user's past history) what type of command will be issued next. Data for the next anticipated (or for a number of commands, anyone of which is anticipated) is accumulated so that a switch may be made without any significant latency.

It should also be noted that while the present invention is applied to the particular system described in co-pending applications 9/860,962 and 09/861,434, the invention can be applied to many types of video streaming systems where a user issues commands, and where there may be some latency involved in gathering data to execute the issued command.

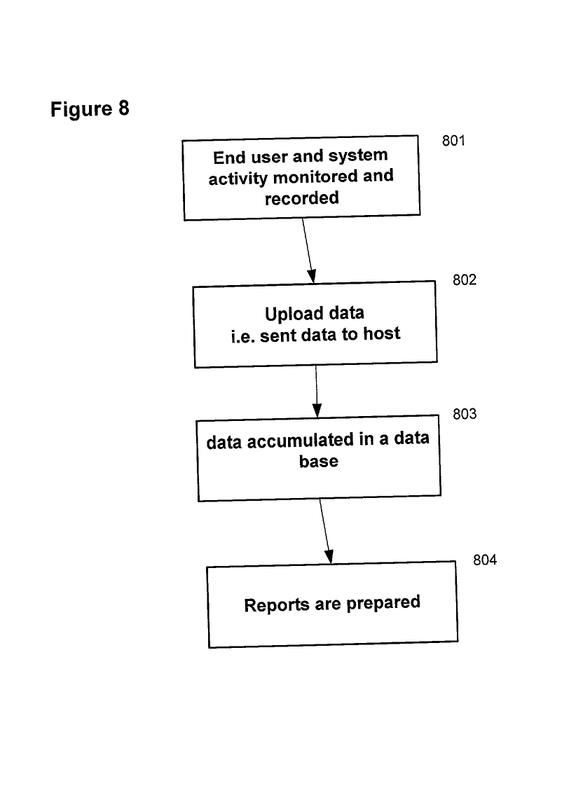

Another aspect of the preset invention is illustrated in FIG. 8. As indicated by block 801, the user activity is monitored for the purpose of accumulating statistical data in order to generate various types of reports. All data particular to a user's operation of the system is recorded. For example, which video clips does the user view, when does he view them and which commands are issued while he is viewing the clips is recorded. This data is recorded at the client and then uploaded to the host computer as indicated by block 802. At the host computer the data is accumulated in a data base as indicated by block 803. Finally reports are prepared as indicated by block 804.

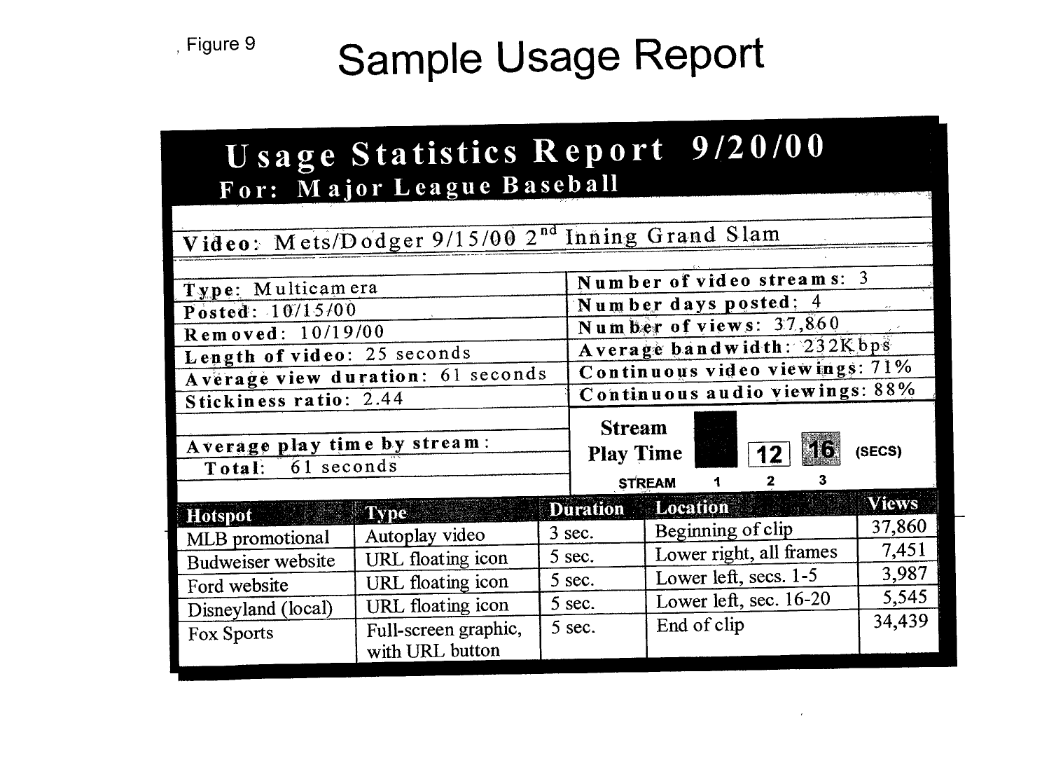

FIG. 9 is an illustration of the type of reports that may be prepared. The report illustrated in FIG. 9 give statistics such as the average duration that a clip is viewed, the number of video streams, the average bandwidth used, how long each stream was viewed, which hotspots were used by the viewer, etc. It should be clearly understood that the report shown in FIG. 9 is illustrative only and a wide variety of different reports can be generated.

While the invention has been shown and described with respect to a plurality of preferred embodiments, it will be appreciated by those skilled in the art that various changes in form and detail may be made without departing from the spirit and scope of the invention. The scope of applicant's invention is limed only by the appended claims.

I claim:

1) A system for displaying to a user a selected one of a plurality of video streams, said selected video stream being a focus stream, said system comprising, a client system which can display said selected video stream, and a composite video containing a thumbnail image of each of said plurality of video streams, a server which receives a plurality of video streams, and said composite video stream, and which provides a selected one of said video streams and said composite video stream to said client system, an input device connected to said client system whereby a user can select one of said thumbnails thereby sending a signal to said server indicating which of said plurality of video streams should be sent to said client system, and an intelligent buffer system which anticipates the commands that will be issued by a user and which accumulates data so that said commands can be executed without any significant latency.

2) The system recited in claim 1 including means for accumulating and storing data concerning the operation of the system and means for preparing reports containing said data.

3) A system which streams data from a server to a client and wherein said client can issue commands which instruct the server to change the data being streamed to the client, an intelligent buffer at said client which gathers data concerning the commands normally issued by a user and which anticipates the next command which said user is likely to issue and which accumulates data so that said command can be executed without significant latency.

4) The system recited in claim 3 including means for accumulating and storing data concerning the operation of the system and means for preparing reports containing said data.

5) The system recited in claim 3 wherein a user can select which of a plurality of data streams are streamed from said server to said client, and wherein said intelligent buffer anticipates which stream a user will select and which accumulates data relative to said anticipated stream.

6) A system for selectively streaming a plurality of data streams from a server to a client, said client including a input device, whereby a user can issue a command to change the data being streamed from said server to said client, said system including an intelligent buffer which anticipates the commands that will be issued by said user and which downloads and stores information to execute the anticipated commands, whereby said commands can be executed with less latency.

7) The system recited in claim 6 wherein said intelligent buffer includes a memory for storing a series of commands issued by said user.

8) The system recited in claim 7 wherein said intelligent buffer includes a prediction program which examines the commands issued by said user and which predicts the next command which will be issued.

9) The system recited in claim 6 including a data gathering and reporting program.

10) The system recited in claim 7 wherein the stored commands issued by said user are utilized to prepare reports of the actions performed by said user.

11) The system recited in claim 6 wherein said intelligent buffer predicts the next command which will be issued by said user.
